(19) United States
(12) Patent Application Publication
(10) Pub. No.: US 2008/0106173 A1
(43) Pub. Date: May 8, 2008

(54) Mobile data/audio/video/interactive presentation cart

(76) Inventor: Miles Anthony Konopka, Forest Hill, MD (US)

Correspondence Address: Fulbright & Jaworski L.L.P., 801 Pennsylvania Avenue, N.W., Washington, DC, 20004-2623, US

(21) Appl. No.: 11/593,489

(22) Filed: Nov. 7, 2006

(51) Int. Cl. B65G 1/04

(52) U.S. Cl. 312/35

(57) ABSTRACT

A mobile classroom presentation cart ergonomically assembles data, audio, video and interactive presentation equipment; provides security and storage for the equipment and related supplies, transports and provides a fully integrated platform for providing audio-visual presentations. An externally adjustable projector shelf provides for convenient adjustment of a projected image while an enlarged projector door provides an expanded light opening extending into a top of the equipment cabinet. A collapsible side shelf is supported by and retains open a front door of the cabinet. Other features support fabrication and/or modification of carts to provide a desired height including sets of cold shear lines and associated mounting holes associated with a selectable lower edge of the cabinet body. A cart of a desired height can be fabricated by cutting along a cold shear line and attaching the body to a base portion using the associated attachment holes and suitable fasteners.

### BACKGROUND OF THE INVENTION

1. Field of the Invention

The present invention is directed to a cart and particularly a mobile classroom presentation cart providing a platform for operating, transporting and securely storing audio-visual equipment.

2. Description of the Related Technology

Since teaching began the teacher to student relationship has been that of presenter of knowledge, to receiver of knowledge. Education in a classroom setting by a teacher to a group of students has proven to be a successful and effective method of teaching. A student in a classroom can ask a question, and not only that student, but the entire class can benefit from the discussion that brings forth it's conclusion. The design of the classroom today is based on a seating arrangement that focuses students towards a teacher. This teacher has various display devices, chalkboard, dry erase board, charts etc. These devices are normally placed in the front of the classroom and are mounted at ergonomic heights to allow optimum viewing by the students and optimum control by the teacher. A large number if not the majority of the classrooms in the world are built and configured in such a manner as described.

Due to limitations in classroom design and available space it is often difficult to integrate effective presentation technology into a classroom space such as was previously described. That is, it is often difficult to optimize and present all of the tools a teacher needs or desires to empower their students with visual information. Many classroom technology solutions compete for available presentation space and/or require the technology to be permanently integrated into and/or installed as part of the classroom. Under these circumstances school systems may be forced by economic constraints to choose some limited number of classrooms that are to include the technology and which classrooms will not. Alternatively, classroom with the technology my not be using it effectively.

In the past a variety of methods existed to provide suitable visual display information. The overhead projector was widely used in classrooms to display real-time and/or preprinted information and project it to a screen in the front of the classroom. Often a video monitor or television set with a VCR or other video playback device was incorporated into a viewing cart to provide a prerecorded and/or off-air broadcast review capability. The previously mentioned processes all required space to be taken from the presentation area in front of the classroom.

Konopka, U.S. Pat. No. 6,315,308, entitled Mobile Data/Audio/Video/Interactive Presentation Cart, describes a mobile platform or cart that ergonomically assembles video, audio, data aid power management devices. This platform aligns these devices to insure their safe transport and optimum presentation capabilities. The platform and arrangement of devices conserves use in a classroom setting to enhance the classroom teachers' presentation capabilities. The Mobile Data/Audio/Video/Interactive Presentation Cart also allows school and classroom teachers to safely transport and share the technology from classroom to classroom as required.

Konopka, et al. U.S. Pat. No. 5,850,250, describes a distance learning classroom system that requires an entire classroom be renovated with technology including a plurality of monitors and cameras, This system while effective in the delivery of distance learning technology is a stand alone classroom and cannot be easily moved to other classrooms in the school. Likewise this classroom little resembles the model of a traditional classroom that has proven effective in its design world wide.

Fraquelli et al. U.S Pat. No. DES. 417,980 displays a platform that is stabilized with a lower wheeled assembly. It has a shelf for computer equipment and a stalk to support it.

Nichoalds U.S. Pat. No. 4,718,741, describes an electrified table top. This table top is mounted on a wheeled cabinet and has a wire management system that allows a power cord to be selectively plugged into a conventional power supply receptacle.

Sweere et al., U.S. Pat. No. 5,918,841 describes a rolling cart for a computer and flat panel display panel includes a base with plural cantered wheels, a mounting pole projecting upward from the base, at least one pole mounted bracket, a pivot support bracket supported by the pole mounting bracket and securing a support arm which is suitable for supporting a flat panel display.

The computer keyboard and flat panel display cart disclosed in Sweere et al. U.S. Pat. No. 5,918,841 has a number of significant drawbacks. For example the computer platform located on shelf 1220 is the means by which bottom loading or stability for the cart is achieved. This assumes that future computers will be of significant weight to overcome the top heavy equipment placed on the upper mounting brackets. The display cart of Sweere et al. also appears to lack means to effectively control the cabling necessary to connect the components mounted on the brackets. And finally this design fails to safely protect the components it supports, a highly desirable requirement in a classroom.

Heretofore, prior art computer carts and electrified tables and support structures have been limited to devices that hold, position and manage devices but did not provide an integrated solution to storage, security transport, and operational positioning of audio-visual and related presentation equipment.

### SUMMARY OF THE INVENTION

The present invention is directed to a mobile classroom presentation cart that ergonomically assembles data, audio, video and interactive presentation equipment; provides security and storage for the equipment and related supplies, transports and provides a fully integrated platform for providing audio-visual presentations. Embodiments of the present invention incorporate features such as an externally adjustable projector shelf and projector hatch or door providing an expanded light opening into a top of an equipment cabinet for projecting an image at least partially through the top of the cabinet. Embodiment further include a collapsible side shelf which, when lifted into a horizontal position for use, is supported by and retains open a front door of the cabinet. Still other embodiments of an equipment cabinet or cart according to the invention facilitate fabrication by including sets of cold shear lines or grooves and associated mounting holes associated with a selectable lower edge of the cabinet body. A cart of a desired overall height can then be fabricated by cutting along a cold shear line as necessary and then attaching the body to a base portion using the associated attachment holes and suitable fasteners.

The present invention includes embodiments having the one or more of the following features:

a) Enclosed ventilated side panels and front and rear side-hinged doors to protect equipment and components from damage and theft;

b) Hinged side shelf swings up into a working position and is supported in place by and rests atop the rear cabinet door ensuring that door is secured open and out of the way so as to provide equipment ventilation during operation;

c) Hinged projector door provides opening extending into portion of top shelf area to accommodate full image projection onto screen from video projector positioned within cabinet;

d) Video Projector tilt shelf has a double tilt axis allowing shelf to (i) rotate about a lateral axis of the projector to adjust picture height as projected onto a screen, and (ii) rotate about a longitudinal axis to adjust and level the projected image;

e) Power cord floorguard is a vinyl protective molding attached to the bottom rear of the cart using an angle bracket to prevent personnel from tripping over the power cord and provide appropriate positioning distance of the cart from the projection surface;

f) Alternate power cord opening provided through and out of bottom shelf of cart;

g) Modular construction providing for adjustable heights; and

h) Internal wire chase for cable management.

Embodiments of the present invention may include features to automatically align and support a video/data projector. This projector, when placed on the designed shelf mounting station, is prepositioned to assume the correct angle for viewing and focus. The target for the images created by the video/data projector may be a suitable viewing surface such as a flat or curved reflective screen such as a projector screen typically located above a classroom chalkboard. This screen may be angled to provide increased and/or near-perfect linearity with the images being projected from the video/data projector. According to a preferred embodiment, during an instructional session, a communications feed, a power feed, and video cable feed may be connect to the cart on one end and, on the other end, to a connectorized outlet. Cables may be housed in a flexible vinyl molding to provide this assembly of feeds. The molding may be connected to the cart and, when it is deployed to the outlet, the length of the molding may automatically establishes the correct focus distance for the video/data projector with respect to a viewing screen. It would be expected that all or most classrooms that are configured to use carts according to various embodiments of the invention will have an outlet to provide the communications, power and video feeds.

Each classroom should also have a viewing screen mounted above the outlet and, for example, above any chalkboard. This viewing screen aligns with the projector to insure images are presented in a linear, undistorted (e.g., minimizing key stoning and similar effects) and clear format. Students and the instructor preferably face the screen to view video and data images. The base of the cart may support and provide adequate storage and mounting room for a computer (e.g., CPU), a printer, and related equipment and/or accessories. These devices may be connected to each other, other equipment installed on the cart, external devices, systems and data/communications networks by cables and wire management systems located in the sides of the cart.

The CPU monitor is supported at some ergonomically advantage height, e.g., average standing eye level, using a shelf. The shelf may include a tie down system that secures the monitor to the cart and reinforces the monitor's stability. A foldable, retractable or permanent keyboard shelf may be located on the front of the cart and provides a stable platform to input data from a person standing in front of it. In a preferred configuration, equipment and other devices are mounted and/or position by, on and in the cart so that a classroom teacher may stand at the cart and present images front the monitor and simultaneously project the images onto a screen.

A CODEC (coder decoder) may be included to provide video teleconferencing capabilities. The CODEC may be mounted and/or installed on the top monitor shelf or on the CPU shelf below. A camera may be mounted on top of the monitor. According to one embodiment the camera may be fixed, manually positionable or have a pan and tilt robotic control.

A document camera may have a mounting station on the monitor shelf and may further include a folding document shelf located below its lens field of view. This documents shelf may be configured for the placement of flat materials, such as papers and books, and/or support 3 dimensional objects such as models, specimen, etc.. The document shelf may be configured to fold downward for transport or when not being used. A single student microphone and a single teacher's microphone may be stored in a storage station located on the base of the cart and deployed external to the cart when in use. According to an alternative configuration, shelves may be fixed to the cart to support one or more loudspeakers in an appropriate position and orientation so as to proved improved sound quality and direct/focus sound at an audience (e.g., students). According to a preferred embodiment, audio may be provided and delivered by a sound system located in the projector with an appropriately located and configured grill and/or other means to allow sound to be directed out from the projector towards the audience. A shelf located in the front of the cart may support video reproduction and playback equipment such as a videocassette recorder (VCR), digital videodisk player (DVD), digital video recorder, etc. This shelf may have suitable wire management resources to support multiple types of such devices, singularly and in combination. The VCR, DVD shelf may be configured to locate the playback device to facilitate quick and unimpeded insertion of videotapes, digital disks, or other changeable media.

A “push and grab bar” may be located in and/or mounted to the front of the cart. This bar provides for cart maneuvering and positioning and maintains screen to projector alignment by the classroom teacher or other user of the cast. The cart may be supported on a soft-wheeled system that uses (2) two ridged and (2) swivel castered wheels.

Additional objects, advantages and novel features of the invention will be set forth in part in the description which follows, and in part will become apparent to those skilled in the art upon examination of the following and the accompanying drawings or may be learned by practice of the invention. The objects and advantages of the invention may be realized and attained by means of the instrumentalities and combinations particularly pointed out in the appended claims.

### BRIEF DESCRIPTION OF THE DRAWINGS

These and other features, aspects and advantages will become clearer with regard to the following description, claims and accompanying drawings wherein the drawing figures depict preferred embodiments of the present invention by way of example, not by way of limitations. In the figures, like reference numerals refer to the same or similar elements.

FIG. 1 is an perspective view of a mobile presentation cart with a front equipment door closed;

FIG. 2 is an perspective view of a mobile presentation cart with a front equipment door in a fully open position, engaging and supporting folding side shelf;

FIG. 3 is a detailed drawing of a locking device for securing the equipment door closed;

FIG. 4 is perspective view of a side and rear a mobile presentation cart;

FIG. 5 is an perspective view of the rear of a mobile presentation cart with rear projector door 401 in a closed position;

FIG. 6 is an enlarged perspective view of an internal projector tilt shelf;

FIG. 7 is an exploded perspective view of a vinyl molding cable assembly;

FIG. 8 is a side view of a mobile presentation cart showing break off indent lines;

FIG. 9 is a rear view of a mobile presentation cart showing break off indent lines; and

FIG. 10 is a side view of mobile presentation cart showing break off indent lines.

### DETAILED DESCRIPTION OF THE PREFERRED EMBODIMENTS

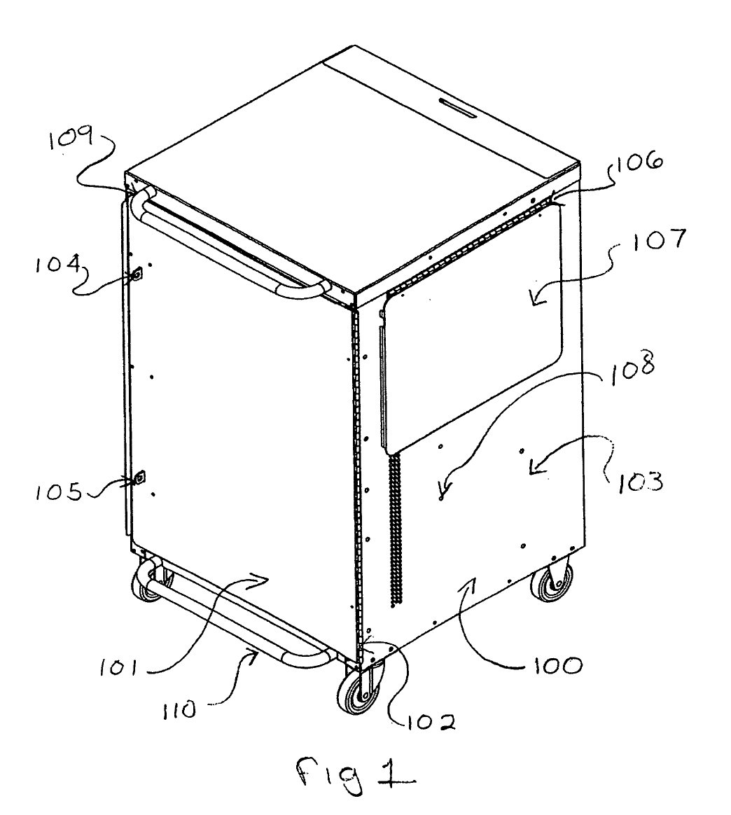

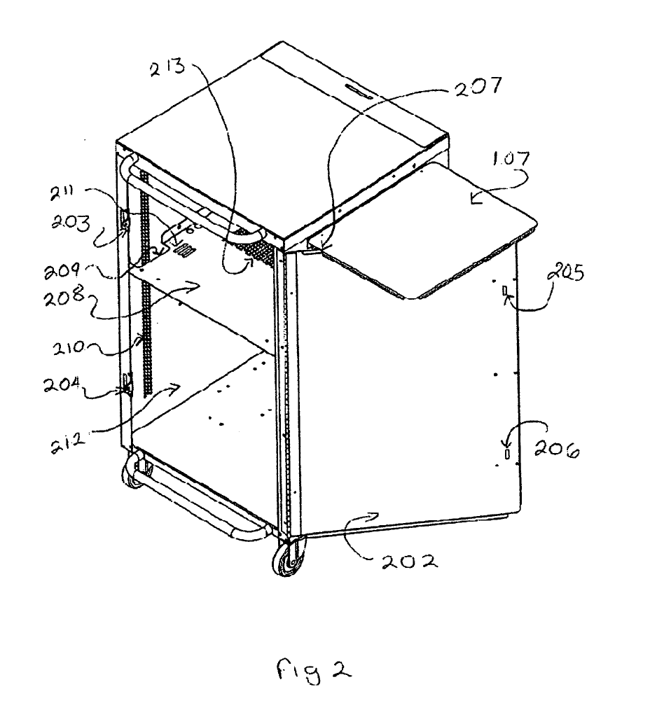

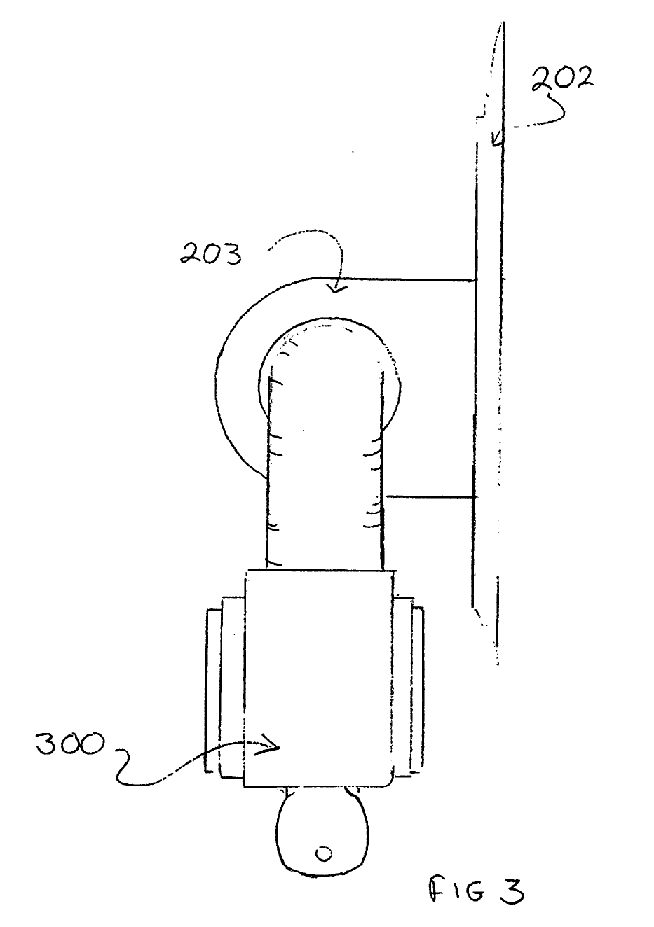

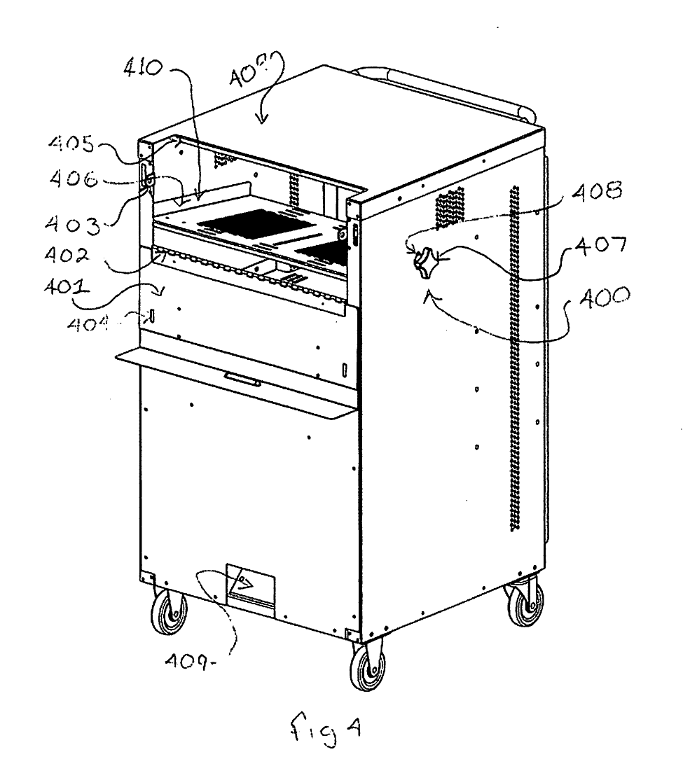

FIG. 1 is a perspective view of the cart 100 with its front equipment door 101 closed. Hinge 102 connects the door to cart side panel 103, and allows the door to swing outward to position 102 as in FIG. 2. In a preferred embodiment hasps 203 and 204 protrude through door slots 205 and 206 as can be viewed in FIG. 1, 104, and 105. This configuration allows a padlock 300 (FIG. 3) to be applied inside the hasp hole 203 preventing door 202 from swinging from it closed/locked position as depicted in FIG. 1 position 101. This arrangement provides for the protective security of the components to be placed inside cart 100.

Folding side shelf 107 in FIG. 1 is attached to side panel 103 using piano hinge 106. When side shelf 107 is in its upright position door 202 may be opened and positioned underneath shelf 107. Shelf 107 is raised slightly above door 202 and side shelf 107 is lowered onto and supported by a tope edge of door 202. Shelf 107 has a slot 207 cut to align and secure door 202 at a fixed 45° angle from side panel 103 when shelf 107 is lowered onto its top surface. This configuration provides optimal support for folding shelf 107 and any objects resting upon the shelf. This configuration maintains the equipment door 202 in an open position during operation of the integrated components and ensure that adequate ventilation is provided for the various equipment and components operating inside of cart 100. Equipment shelf 208 is a flat surface with openings 209, 210 that allow connector wires and cables to flow up and down inside of the cart. Hole pattern 210 provides a connection point for plastic wire cable ties and aligns them into opening 209 of equipment shelf 208. The mobile cart is includes a plurality of drilled, punched, or otherwise formed holes 108 that allow a plurality of shelves 208 to be positioned and attached to walls or side panels 103 and 212 suing appropriate brackets or other attachment hardware or devices. Shelf 208 is perforated with slots 211 that provide anchor points for equipment hold down straps (not shown). Shelf 208 is also perforated with ventilation holes 213 to assist in and facilitate equipment cooling and cable attachment.

Push handle 109 is a tubular structure attached to a top portion of cart 100 and is ergonomically designed to provide a grip point to control movement of the cart. Foot push bar 110 is a similar tubular structure albeit attached at lower portion of cart 100, ergonomically designed to provide a stationary pedal to leverage the cart upward over room to room thresholds.

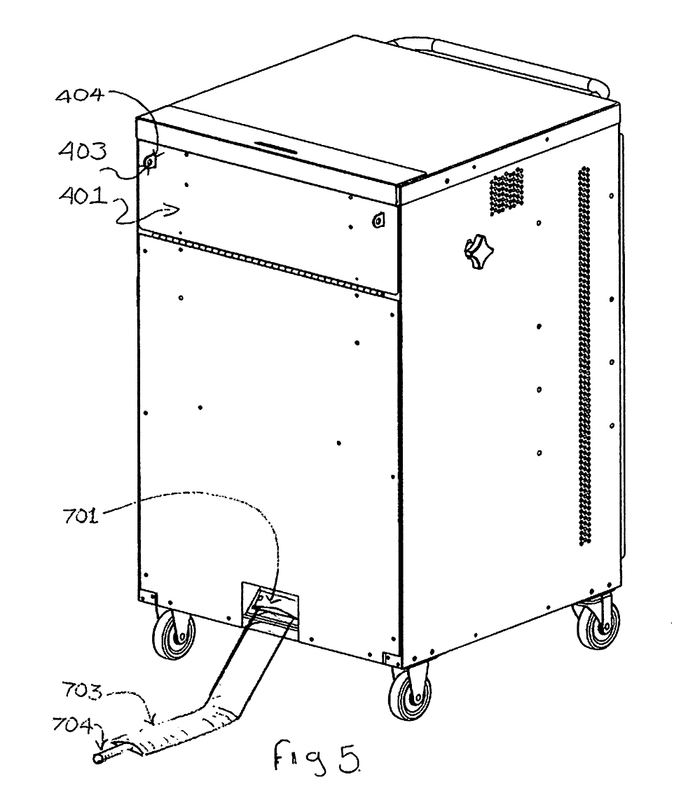

FIG. 4 is a side and rear perspective of cart 100. Rear projector door 401 is attached to a rear panel of cart 100 by hinge 402 to swing up and downward to cover projector opening 405. Projector opening 405 provides unique clearance above and in front of an LCD projector within cart 100 on projector tilt shelf 406. This design allows the cone shaped light that projects from an LCD projector to clear the top of the enclosing structure 409. This top clearance allows the LCD projector to be tilted at an aggressive angle on LCD tilt shelf 406. The light projection geometry inherent in all LCD projectors allows shelf 406 working in concert with opening 405 to optimize LCD projector projection angles insuring the light projection geometry does not strike the inside edges of opening 405.

Projector tilt shelf 406 pivots upward and downward on pivot point 410 and locking knob 407. Locking knob 407 is threaded into the tilt shelf 406. Clockwise rotation tightens knob 407 against cart wall 400. When locking knob 407 is tightened so as to secure the knob against wall 400, projector tilt shelf 406 is thereby locked into and secured in position. Projector tilt shelf 406 also yaws from side to side, i.e., rotates about a lateral axis for adjusting a tilt of the shelf whereby a leveling of the projected image may be achieved. Pivot point 410 is loosely fitted to shelf 406. Slot 408 located on wall 400 allows projector tilt shelf 406 to yaw from side to side when locking knob 407 is loosened and moved up and down within yaw slide slot 408, i.e., adjusted about a transverse axis connecting locking knob 407 and pivot point 410 for adjusting a pitch of the shelf whereby a vertical positioning of a projected image may be achieved. FIG. 4 shows the projector tilt shelf 406 tilted slightly upward about its transverse axis and the side to side yaw is level and centered in yaw slide slot 408, i.e., about its lateral axis.

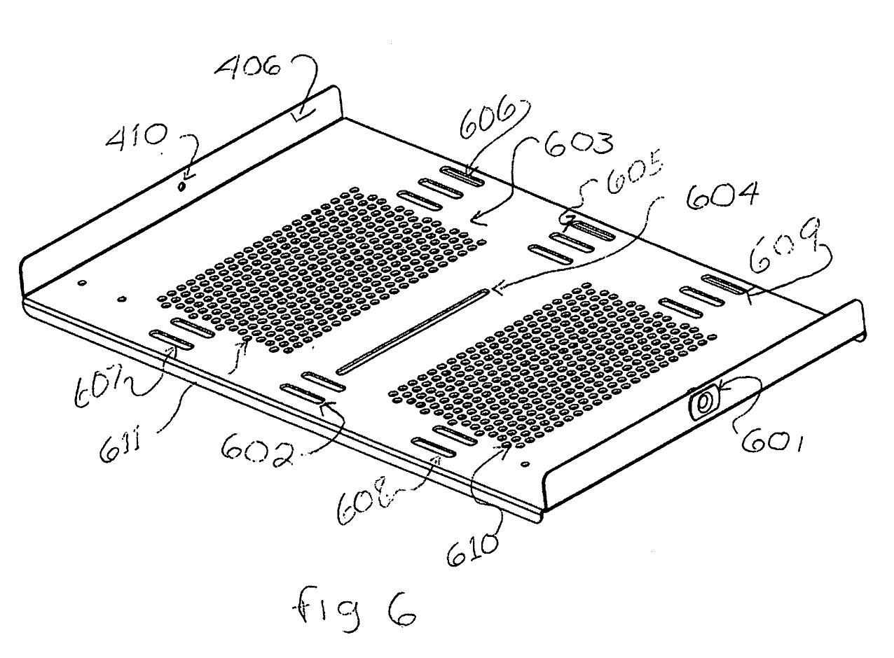

FIG. 5 is a perspective view of the rear of the cart with rear projector door 401 in the upward and closed position. Hasp 403 is protruding through slot 404 to provide means for locking door 401 in an closed position. Projector door 401 completely closes the opening 405 and secures access to the inside of cart 100 through opening 405. In a preferred embodiment, padlocks are placed in hasp holes 403, preventing slot 404 in door 401 from sliding over hasp 403. In an alternate embodiment flush mounted key locks may be placed on door 401 and lock bars rotated into a locked position behind the side walls 103 and 400 to prevent door 401 from opening. FIG. 5 also demonstrates the vinyl cable molding assembly 703 in a deployed configuration for providing a conduit from the equipment mounted in cart 100 to external connection points. This assembly attaches to the cart with friction clamp 701 that also secures vinyl molding assembly 703 with its communications cable(s) 704 to the cart structure. When cut to the proper length the vinyl cable molding assembly establishes critical cart-to-viewing-screen distances and provides a flat non-trip cable path.

FIG. 6 is an enlarged perspective view of projector tilt shelf 406. Strap slots 602, 605, 606, 607, 608, 609 are designed to provide strap hold down points for an LCD projector (or other equipment) placed on top of shelf 406. This strap and slot configuration allows positive attachment of the projector to the shelf during tilt and yaw adjustments so as to positively secure the projector to the shelf and avoid slippage and movement. In addition to strap slots 602, 605, 606, 607, 608, 609 a longer slot 604 is provided to attach a through-bolt to the proposed LCD projector. Hole patterns 610 and 611 are designed to allow flow through ventilation from below the shelf 406 provided by natural or forced-air convention.

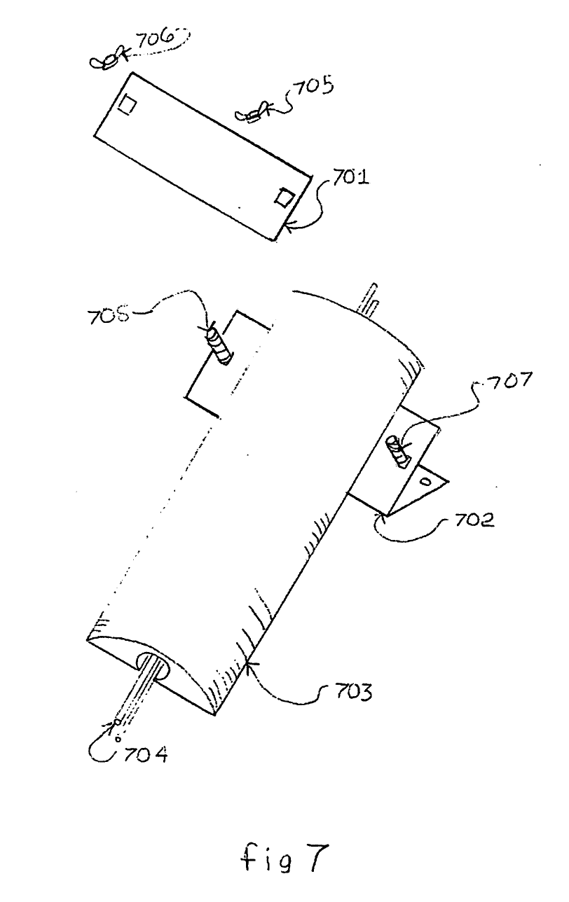

FIG. 7 is an exploded perspective view of the vinyl molding cable assembly 703 and clamp 701. This assembly is anchored to the cart using anchor base 702 that is attached to the cart. Bolts 707, 708 are permanently fixed to anchor base 702. The bolts are of sufficient length to allow the vinyl molding cable assembly 703 to be placed between bolts 707,708 and allow clamp 701 to be tightened down in place over the assembly using wing nuts 705,706. This assembly allows the vinyl molding 703 to protrude through opening 409 as seen in FIG. 4.

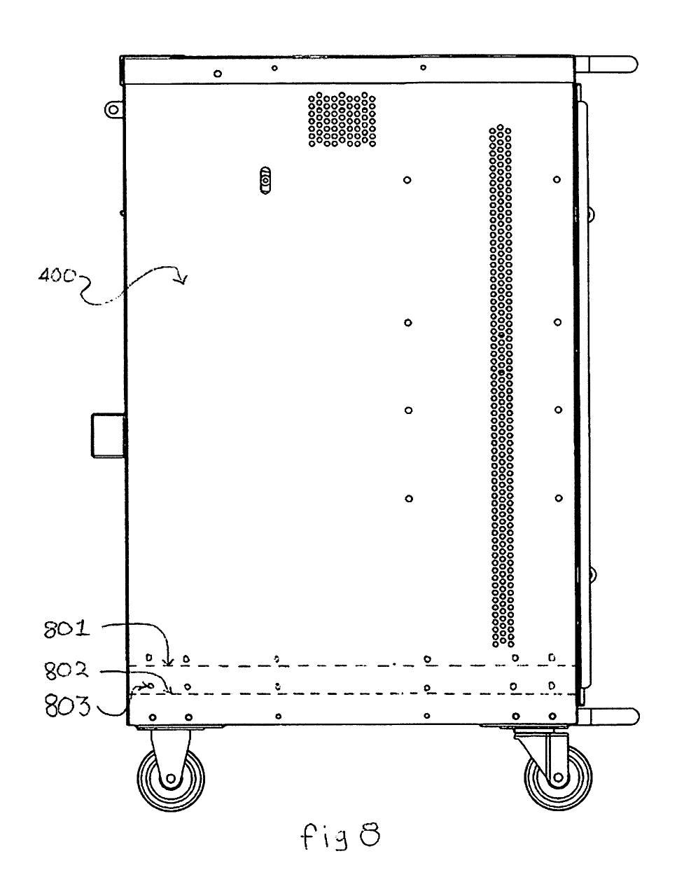

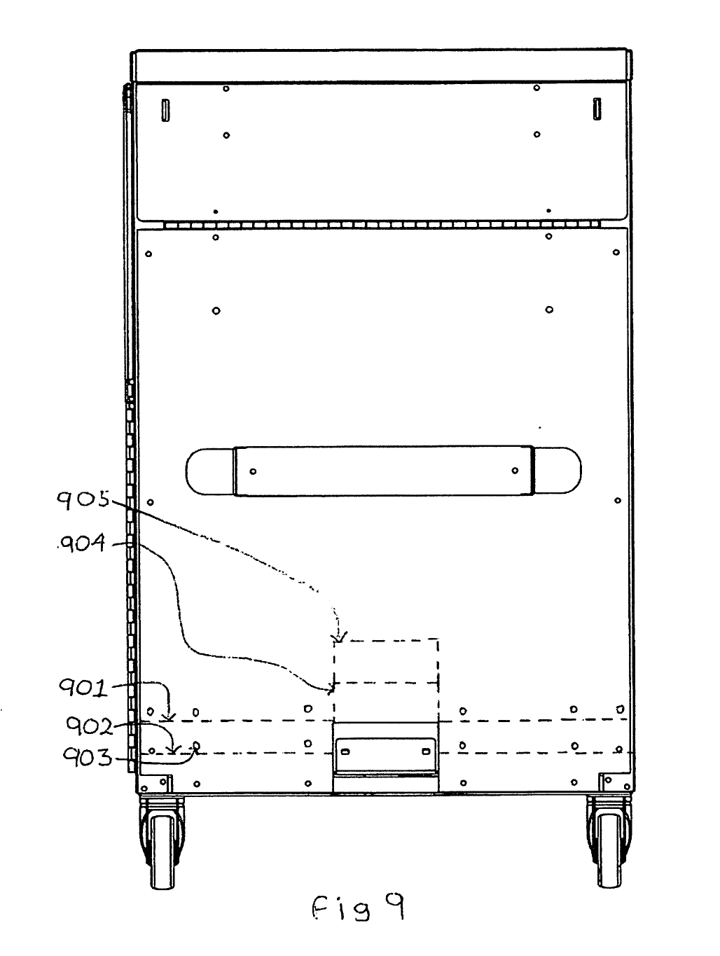

FIG. 8 is a side view 400, of cart 100 depicting break off indent lines 801,802, also referred to as score lines. Score lines 801,802 may be produced by etching during the material press process that provide measured, incremental, cut points. Cut points provided by score lines 801,802 provide measured, incremental, cart height adjustment or fabrication points when material is removed below lines 801, 802. This process also replicates attachment holes 803 to align with the altered side 400, allowing it to be attached securely and successfully. The break off process is performed in the last stages of manufacturing. It provides to the production of a single height of side 400 that can be later readily modified and incrementally adapted during assembly to a specific desired height as customer requirements are identified.

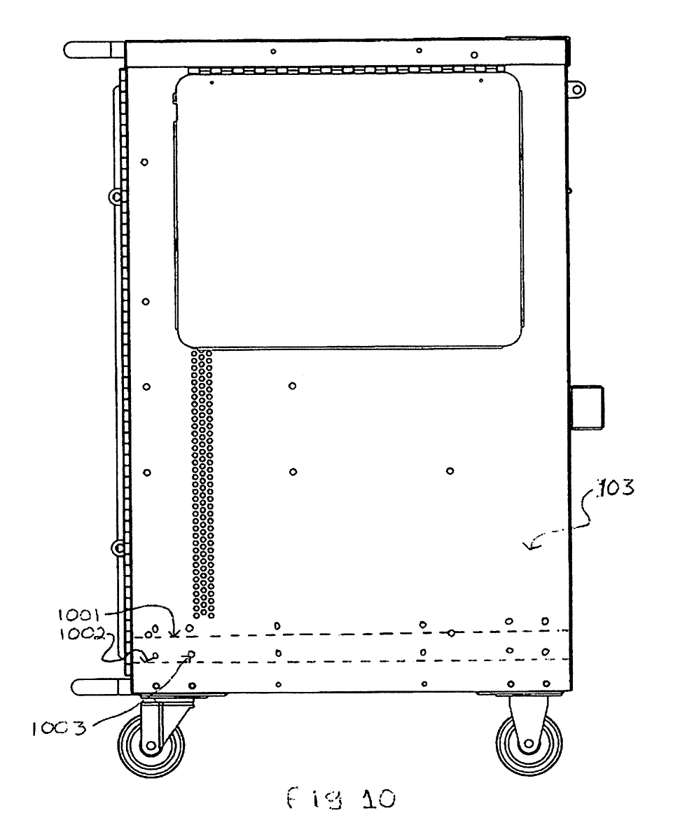

FIG. 9 is a rear view of the cart showing break off indent or score lines 901,902. Score lines 901,902 are etched lines produced in the material press process that provide measured, incremental, cut points. Cut points implemented by score lines 901,902 provide measured, incremental, cart height adjustment when material is removed below lines 901,902. This process also replicates attachment holes 903 to align with the altered rear of the cart, allowing it to be securely and successfully attached. Cut outs 904,905 provide accurate cut points to align with cut points 901,902. The break off process is performed in the last stages of manufacturing and/or as part of an assembly process so as to provide for mass production of a standard, maximum height rear panel that may be readily incrementally shortened as customer requirements are identified.

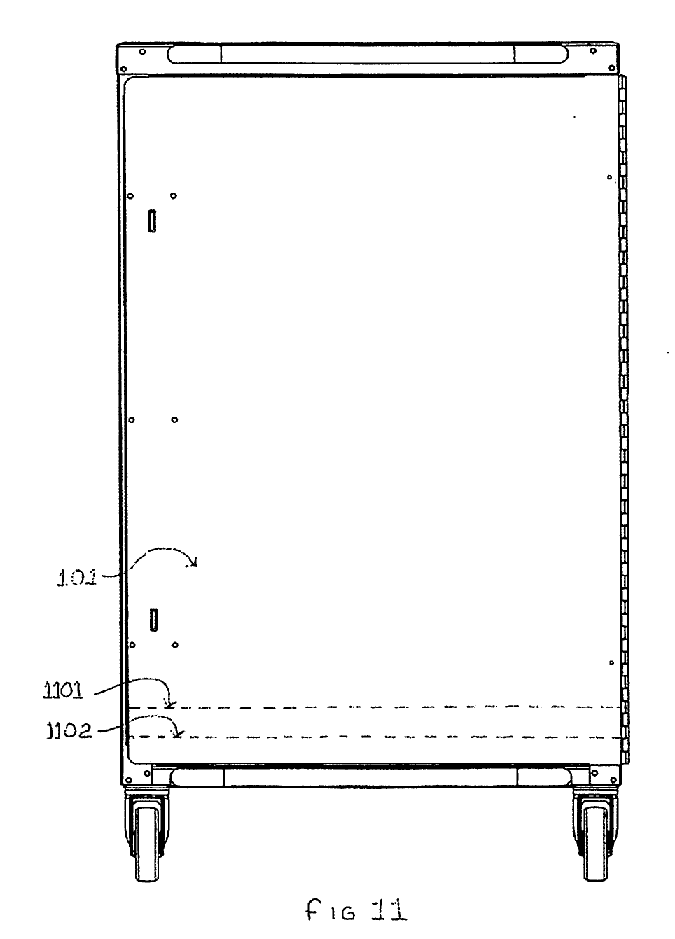

FIG. 10 is a side view 103, of the cart showing break off indent or score lines 1001, 1002. Score lines 1001,1002 are etched lines produced in the material press process that provide measured, incremental, cut points. Cut points 1001, 1002 provide measured, incremental, cart height adjustment when material is removed below lines 1001, 1002. This process also replicates attachment holes 1003 to align with the altered side 103, allowing it to be attached successfully. The break off process is performed in the last stages of manufacturing. It allows only (1) one side 103 to be mass produced and then altered incrementally as customer requirements are identified.

While the foregoing has described what are considered to be the best mode and/or other preferred embodiments of the invention, it is understood that various modifications may be made therein and that the invention may be implemented in various forms and embodiments, and that it may be applied in numerous applications, only some of which have been described herein. It is intended by the following claims to claim any and all modifications and variations that fall within the true scope of the inventive concepts.

It should also be noted and understood that all publications, patents and patent applications mentioned in this specification are indicative of the level of skill in the art to which the invention pertains. All publications, patents and patent applications are herein incorporated by reference to the same extent as if each individual publication, patent or patent application was specifically and individually indicated to be incorporated by reference in its entirety.

What is claimed is:

1. An equipment cabinet comprising:
an enclosure including a front door; and
an articulatable internal shelf mounted inside said enclosure, said internal shelf including a handle extending outside said enclosure for externally positioning said internal shelf.

2. The equipment cabinet of claim 1 wherein said handle includes a locking mechanism for securing said internal shelf in a desired position.

3. The equipment cabinet of claim 1 wherein said articulatable internal shelf is positionable about two axes of rotation.

4. The equipment cabinet of claim 1 wherein said articulatable internal shelf is positionable about a transverse axis for adjusting a pitch of the shelf whereby a vertical positioning of a projected image may be achieved and about a lateral axis for adjusting a tilt of the shelf whereby a leveling of the projected image may be achieved.

5. The equipment cabinet of claim I further comprising a projector door spanning a top and side of said enclosure.

6. The equipment cabinet of claim 5 further comprising a collapsible side shelf mounted to a side of said enclosure, said collapsible shelf supported in a working position by said front door when open.

7. The equipment cabinet of claim 1 further comprising a collapsible side shelf mounted to a side of said enclosure, said collapsible shelf supported in a working position by said front door when open.

8. The equipment cabinet of claim I further comprising a plurality of casters attached to a bottom of said enclosure.

9. The equipment cabinet of claim 1 further comprising a power cord floorguard attached to a bottom of the enclosure and having routed therethrough a power cord for supplying power to equipment mounted in said enclosure.

10. The equipment cabinet of claim 1 further comprising an wire chase internal to said enclosure for routing cables within said enclosure.

11. The equipment cabinet of claim 1, said enclosure comprising a base section and a plurality of side panels attached to said base, said side panels secured to said base section by a plurality of fasteners extending through an arrangement of holes formed in said side panels and corresponding arrangement of holes formed in said based section, said side panels including a plurality of said arrangement of holes, one of said arrangements of holes spaced a predetermined distance from a bottom edge of said side panels and others of said arrangements of holes spaced said predetermined distance from respective score lines formed parallel to said bottom edge.

12. An equipment cabinet comprising:
an enclosure including a front door; and
an a projector door spanning a top and side of said enclosure.

13. The equipment cabinet of claim 12 wherein said projector door is hinged along a lower edge thereof to said side of said enclosure so as to open downward and expose a projector mounted on an internal shelf whereby a light image projected by the projector is not obstructed by said top of said enclosure.

14. The equipment cabinet of claim 12 further comprising a collapsible side shelf mounted to an outside of said enclosure, said collapsible shelf supported in a working position by said front door when open.

15. The equipment cabinet of claim 12 further comprising a plurality of casters attached to a bottom of said enclosure.

16. The equipment cabinet of claim 12 further comprising a power cord floorguard attached to a bottom of the enclosure and having routed therethrough a power cord for supplying power to equipment mounted in said enclosure.

17. The equipment cabinet of claim 12, said enclosure comprising a base section and a plurality of side panels attached to said base, said side panels secured to said base section by a plurality of fasteners extending through an arrangement of holes formed in said side panels and corresponding arrangement of holes formed in said based section, said side panels including a plurality of said arrangement of holes, one of said arrangements of holes spaced a predetermined distance from a bottom edge of said side panels and others of said arrangements of holes spaced said predetermined distance from respective score lines formed parallel to said bottom edge.

18. An equipment cabinet comprising:
an enclosure including a front door; and
a collapsible side shelf mounted to a side of said enclosure, said collapsible shelf supported in a working position by said front door when open.

19. The equipment cabinet of claim 18 wherein said side shelf includes a notch for engaging a top edge of said front door in said open position.

20. The equipment cabinet of claim 18 further comprising a plurality of casters attached to a bottom of said enclosure.

21. The equipment cabinet of claim 18 further comprising a power cord floorguard attached to a bottom of the enclosure and having routed therethrough a power cord for supplying power to equipment mounted in said enclosure.

22. The equipment cabinet of claim 18 further comprising an wire chase internal to said enclosure for routing cables within said enclosure.

23. The equipment cabinet of claim 18, said enclosure comprising a base section and a plurality of side panels attached to said base, said side panels secured to said base section by a plurality of fasteners extending through an arrangement of holes formed in said side panels and corresponding arrangement of holes formed in said based section, said side panels including a plurality of said arrangement of holes, one of said arrangements of holes spaced a predetermined distance from a bottom edge of said side panels and others of said arrangements of holes spaced said predetermined distance from respective score lines formed parallel to said bottom edge.

24. An equipment cabinet comprising a base section and a plurality of side panels attached to said base, said side panels secured to said base section by a plurality of fasteners extending through an arrangement of holes formed in said side panels and corresponding arrangement of holes formed in said based section, said side panels including a plurality of said arrangement of holes, one of said arrangements of holes spaced a predetermined distance from a bottom edge of said side panels and others of said arrangements of holes spaced said predetermined distance from respective score lines formed parallel to said bottom edge.

25. A method of constructing a structure comprising the steps of:
forming, in a base section of the structure, a set of first attachment points in a predetermined configuration;
forming, in an upper section of the structure, a plurality of sets of second attachment points, each of said sets of second attachment points in a configuration corresponding to said predetermined configuration, one of said sets of second attachment points formed proximate a lower edge of said upper section, others of said set of second attachment points formed proximate a respective cold shear line;
selectively cutting said upper section to a desired height piece;
aligning a lowest set of said second attachment points with said set of first attachment points and inserting fasteners therethrough so as to secure said upper section to said base section.
